(19) United States
(12) Patent Application Publication
(10) Pub. No.: US 2026/0023667 A1
(43) Pub. Date: Jan. 22, 2026

(54) NON-INTERRUPTIVE RUN-TIME LOGIC BUILT-IN SELF-TEST FOR A MACHINE LEARNING ACCELERATOR

(71) Applicant: SiMa Technologies, Inc., San Jose, CA (US)

(72) Inventors: Saurabh Jain, San Jose, CA (US); Vishvabhusan Pati, Sunnyvale, CA (US); Ching Hu, San Jose, CA (US)

(21) Appl. No.: 19/262,332

(22) Filed: Jul. 8, 2025

Related U.S. Application Data
(60) Provisional application No. 63/673,260, filed on Jul. 19, 2024.

(51) Int. Cl. G06F 11/25; G06F 11/22; G06F 11/27

(52) U.S. Cl. CPC G06F 11/25; G06F 11/2263; G06F 11/27

(57) ABSTRACT

Run-time logic built-in self-test (LBIST) may be performed, while ensuring operational continuity. The compute elements in a machine learning accelerator contain LBIST circuitry that performs logic testing of the functional circuitry in the compute element. The LBIST circuitry may be self-sufficient, meaning that it contains the data and instructions needed to run and evaluate these tests. An LBIST manager enables the logic testing during idle time of the functional circuitry between blocks of statically scheduled instructions. As a result, the LBIST circuitry can perform the logic tests without disrupting the computation of the machine learning network.

### CROSS-REFERENCE TO RELATED APPLICATION(S)

This application claims priority under 35 U.S.C. § 119 (e) to U.S. Provisional Patent Application Ser. No. 63/673,260, “Non-Interruptive Run-Time Logic Built-In Self-Test for a Machine Learning Accelerator,” filed Jul. 19, 2024. The subject matter of all of the foregoing is incorporated herein by reference in its entirety.

### BACKGROUND

### 1. Technical Field

This disclosure relates generally to the implementation of machine learning networks on hardware and more particularly to built-in self tests for such hardware.

### 2. Description of Related Art

Machine learning is one of the most powerful recent trends in technology. In machine learning, a model is developed to perform a certain task. The model, which will be referred to as a machine learning network, is trained and deployed in order to carry out that task. For example, a model may be developed to recognize the presence of objects within images captured by a set of cameras. Once the model is deployed, images captured by the cameras are input to the machine learning network, which then outputs whether or to what confidence level objects are present within the images.

Machine learning networks typically require the handling of a large volume of data and the execution of a large number of computations. As a result, they are commonly implemented in compute facilities with access to significant resources, such as in the cloud or on server clusters. There can be many advantages if the machine learning network was instead embedded on edge devices, such as combined in a camera system. However, many types of edge devices, such as cameras, have resource limitations. They may be limited in memory, processing capability, power consumption, etc. As a result, on-chip compute elements may be simplified to conserve resources.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIG. 1 is a block diagram of a machine learning accelerator (MLA) with logic built-in self-test (LBIST).

FIGS. 2A and 2B are block diagrams of a processing element with LBIST circuitry.

FIG. 3A is a block diagram of a system providing instructions to compute elements in a machine learning accelerator (MLA).

FIG. 3B is a diagram illustrating instruction transfer to compute elements.

FIG. 4 is a timing diagram showing logic tests executed during idle time.

FIG. 5 is another timing diagram showing logic tests executed during idle time.

FIG. 6 is a block diagram of testing compute circuitry in a processing element.

FIG. 7 is a block diagram of testing an instruction decoder in a processing element.

FIG. 8A is a block diagram of a system with an MLA and corresponding compiler.

FIG. 8B is a block diagram of a hardware system including an MLA.

FIG. 8C illustrates execution of a statically scheduled program produced by a compiler.

FIG. 9 is a block diagram of a software development environment including a machine learning (ML) compiler.

FIG. 10 is a block diagram of an integrated circuit that includes an MLA.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Machine learning networks (MLNs) are commonly implemented in compute facilities with access to significant resources, such as in the cloud or on server clusters. However, the sources of input to machine learning networks may be located remotely from these large compute facilities. For example, cameras and other types of sensors may be edge devices. Example applications for edge devices include automotive and other forms of transportation including autonomous transportation, agricultural, industrial, robotics, drones, surveillance and security, smart environments including smart cities, medical and personalized health. Example tasks include computer vision, image analysis, image understanding, speech recognition, audio analysis, audio understanding, natural language processing, classification and pattern recognition tasks. For edge devices, it may be desirable to perform certain tasks in real-time. In addition to memory and other programmable processors, an edge device may also include sensors, such as cameras including both still image and video cameras, microphones, temperature sensors, pressure sensors and other types of sensors. The sensors may capture samples that are used as inputs to a computing pipeline within the edge device. Thus, it would be beneficial if MLNs could be implemented in edge devices.

A machine learning accelerator (MLA) is described herein that may be built into an edge device. The MLA executes a machine learning network. As described in more detail below, one method of optimizing execution of an MLN is to use a compiler that, prior to run-time, generates a computer program with statically scheduled blocks of instructions for executing the MLN. For example, the compiler may determine, for each block, which instructions are executed by which compute elements in the MLA at what time. Static scheduling enables the compute elements in the MLA to execute the instructions with no run-time conditions, branching or dependencies. This may result in lower power consumption, simpler MLA design, and lower cost.

Logic built-in self-test (LBIST) is a mechanism to check for functional integrity of compute elements. Normally, LBIST can be performed at boot time or shutdown time, but not while an integrated circuit (e.g., an MLA) is processing tasks, i.e. at run-time. If LBIST is performed at run-time, the MLA may have a performance degradation or unacceptable operational interruption. For statically scheduled instructions, run-time LBIST may delay some compute elements relative to others, thereby violating the static schedule.

This disclosure describes an approach in which run-time LBIST may be performed, while ensuring operational continuity. The compute elements in the MLA contain LBIST circuitry that performs logic testing of the functional circuitry in the compute element. The LBIST circuitry may be self-sufficient, meaning that it contains the data and instructions needed to run and evaluate these tests. An LBIST manager enables the logic testing during idle time of the functional circuitry between blocks of statically scheduled instructions. As a result, the LBIST circuitry can perform the logic tests without disrupting the computation of the machine learning network.

This non-interruptive LBIST capability is especially important for safety critical or mission critical applications, such as automotive, medical, or defense applications. Naturally occurring radiation such as neutrons or low energy alpha particle emissions may trigger random logic faults in a chip. Random faults may also be caused by heat or power surge. LBIST may be used to detect random faults.

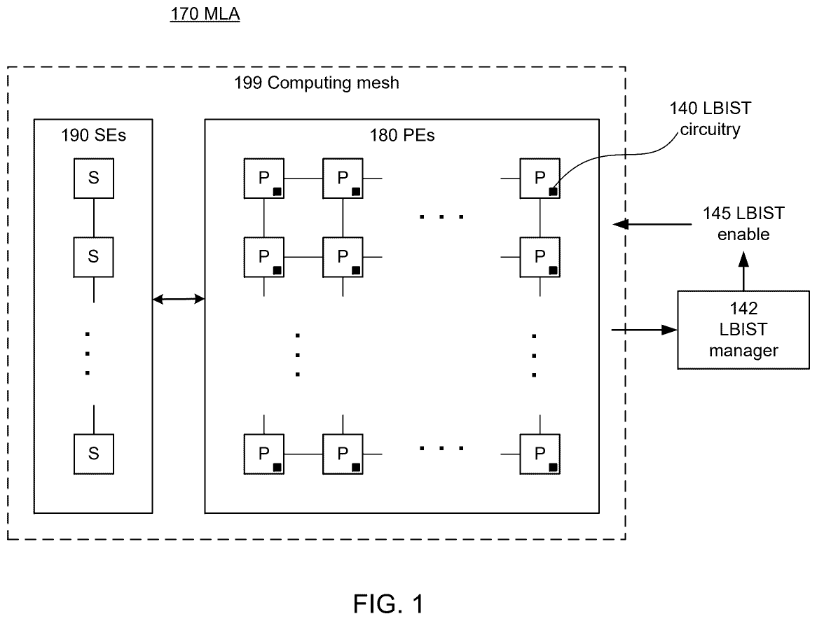

FIG. 1 is a block diagram of a machine learning accelerator (MLA) with LBIST. The MLA 170 includes a mesh 199 of compute elements, which in this example includes interconnected storage elements (SEs) 190 and processing elements (PEs) 180. The compute elements execute blocks of instructions in order for the computing mesh to execute a machine learning network. Within the computing mesh 199, data can be transferred between the SEs 190 and/or PEs 180 according to statically scheduled data transfer instructions. The PEs 180 perform computations according to statically scheduled compute instructions. These data transfer and compute operations within the mesh 199 are deterministic, meaning that the compiler may determine at compile time how many cycles are required to execute each instruction. As a result, these instructions may be statically scheduled by the compiler. They are then executed by the compute elements 180, 190 within mesh 199 according to the static schedule. The static schedule is timed by a common clock.

The MLA 170 also includes a logic built-in self-test capability, which includes LBIST circuitry 140 and an LBIST manager 142. The local LBIST circuits 140 are shown in FIG. 1 as small black squares, only one of which is labeled as 140. The LBIST circuits 140 are located in the compute elements and perform logic testing of functional circuitry within the compute elements. For example, the compute elements may include circuitry for multiply, add and/or nonlinear functions, and the LBIST circuits 140 may be used to test these functions. In FIG. 1, the LBIST circuits are shown only for the PEs, but they may also be incorporated into SEs. In some implementations, each compute element includes a dedicated LBIST circuit 140 embedded in the compute element. The dedicated LBIST circuit 140 performs the logic tests for that compute element during times when the compute element would otherwise be idle. In this way, the logic tests may be performed without affecting the operational efficiency of the MLA in calculating the machine learning network.

The LBIST manager 142 controls the LBIST circuits 140. In this example, the LBIST manager generates an LBIST enable signal 145 that indicates when logic tests may be run. The LBIST manager 142 may also provide other types of control, such as providing data or instructions for use by the LBIST circuits 140 or configuring the LBIST circuits. The results of the logic tests may be evaluated and acted upon internally within the compute elements 180, 190. They may also be sent to the LBIST manager 142 or other destinations for evaluation and action.

For convenience, the LBIST manager 142 is shown in FIG. 1 as a single block located outside the computing mesh 199. This is not required. There may be several LBIST managers, or the LBIST manager may be implemented in a distributed fashion. The LBIST manager circuitry may be either inside or outside the computing mesh, or partly inside and partly outside. In one approach, the LBIST manager 142 is distributed locally to each compute element 180, 190, for the control of the LBIST circuitry 140 within that compute element.

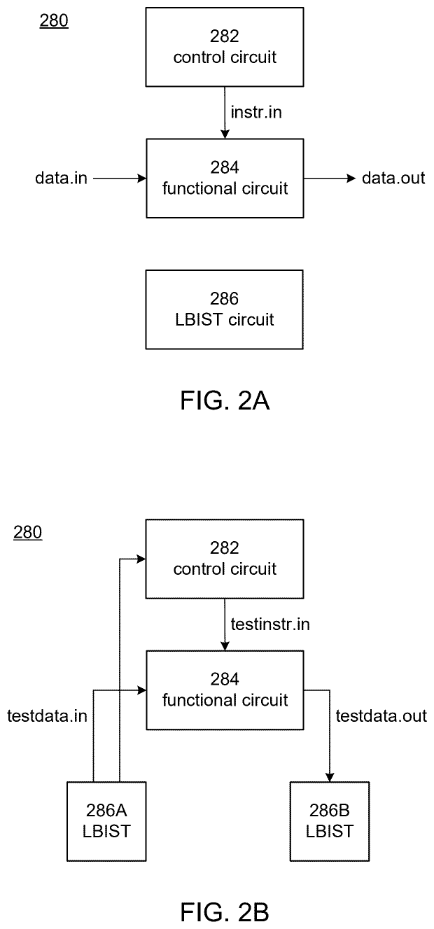

FIGS. 2A-2B are block diagrams of an example processing element 280. The PE 280 includes control circuitry 282, functional circuitry 284 and LBIST circuitry 286. For example, the functional circuitry 284 may be the compute pipeline of the PE 280. The control circuitry 282 may be an instruction decoder.

In FIG. 2A, the compute pipeline (functional circuitry 284) carries out the functions determined by the instructions from the control circuitry 282. The functional circuitry 284 receives data.in and generates corresponding data.out, based on the received instructions instr.in. Common functions for calculating machine learning networks include addition, multiplication and lookup tables for implementing nonlinear functions. The LBIST circuit 286 is not used in FIG. 2A.

FIG. 2B shows logic testing performed by the LBIST circuit 286. In this example, the LBIST circuit 286, shown as two boxes 286A,B for convenience, controls the various inputs and outputs. It provides testdata.in and testinstr.in. The resulting output testdata.out is captured by the LBIST circuit 286B. This testdata.out may be compared to the known good output to determine whether the functional circuitry 284 is faulty.

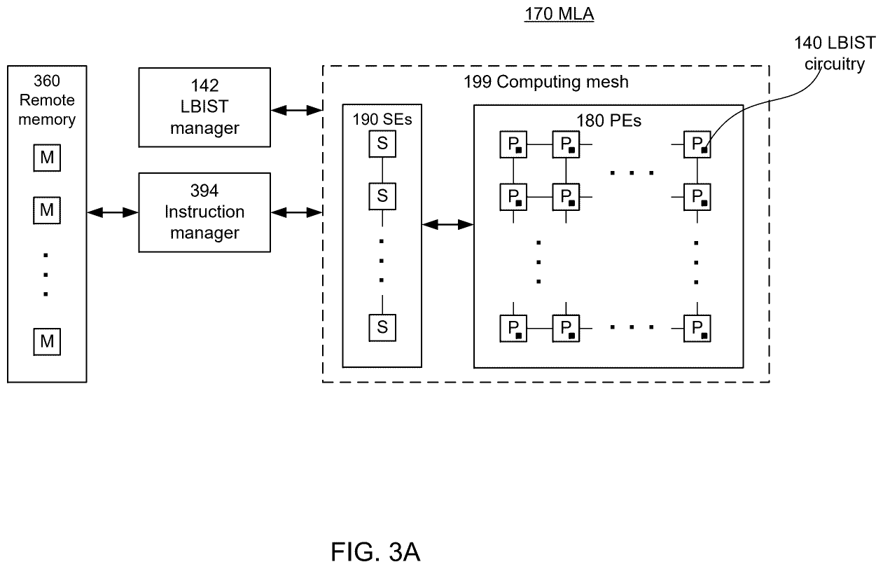

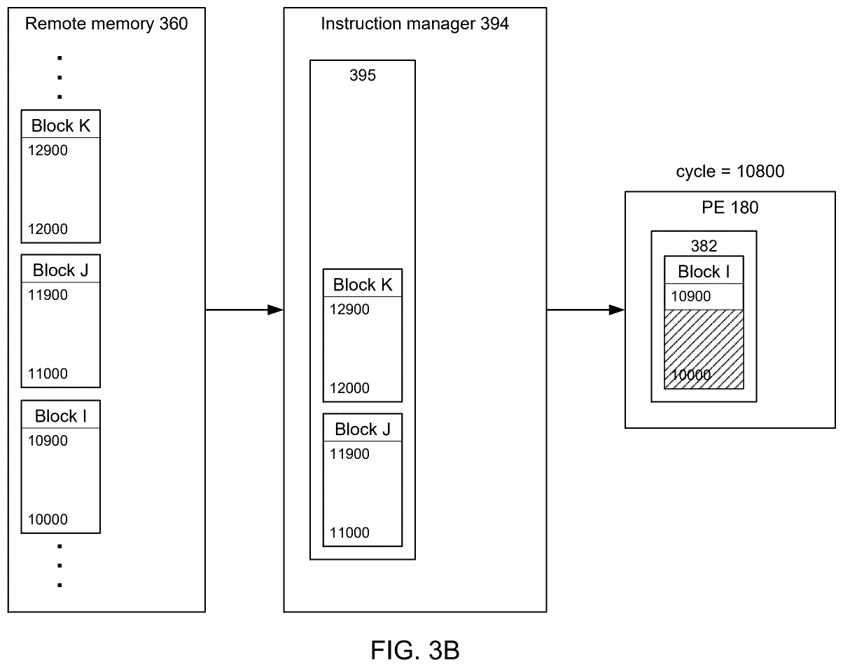

FIGS. 3-5 show a specific example. FIG. 3A is a block diagram of a system providing instructions to compute elements in a machine learning accelerator (MLA). The system includes an MLA 170 as described in FIG. 1. The system in FIG. 3A also includes an off-chip memory 360. The MLA 170 fetches instructions from the off-chip memory 360 for the computing mesh 199. The MLA 170 may do this through a dedicated memory interface, such as a direct memory access (DMA) interface.

The MLA 170 also includes an instruction manager 394. The manager 394 manages the transfer of instructions between the remote memory 360 and the compute elements 180, 190. In FIG. 3A, the manager 394 is shown as a box separate from the computing mesh 199. However, it may be implemented in a distributed fashion as part of each compute element 180, 190. The instruction manager 394 receives instructions from the off-chip memory 360 and transfers blocks of instructions to the computing mesh 199 for execution.

FIG. 3B is a diagram illustrating instruction transfer to compute elements. FIG. 3B shows the remote memory 360, instruction manager 394 and a single processing element (PE) 180. The PE 180 has an instruction queue 382. The instruction manager 394 also has a queue 395. The instruction manager 394 receives blocks of instructions from the remote memory 360 and buffers them in its queue 395. It then transfers these blocks to the instruction queue 382 of the relevant PE 180, which executes each block of instructions according to the static schedule. This example considers the transfer of instructions to a single PE 180. As shown in FIG. 3B, the instructions are originally stored in the remote memory 360. The instructions are divided into blocks, which are to be executed sequentially according to a static schedule.

FIG. 3B shows blocks I, J, K, where block I is executed before block J, which is executed before block K. The instructions within each block are statically scheduled, so the compiler knows when each instruction will execute. This is also shown in FIG. 3B. The instructions in block I begin execution on cycle count 10000 and complete execution on cycle count 10900. The instructions in block J begin on cycle count 11000 and complete on cycle count 11900. The instructions in block K begin on cycle count 12000 and complete on cycle count 12900.

FIG. 3B shows the situation late in the execution of block I. The execution cycle count=10800. Most of block I has executed, as denoted by the cross-hatching. However, in this example, all of block I must execute before the instruction queue 382 is freed to receive block J. Therefore, block J still cannot be transferred to the instruction queue at execution cycle count=10800, so the instruction manager 394 continues to hold block J. Once block I finishes execution (at cycle count=10900), block J may then be transferred to the instruction queue 382. This instruction fetch occurs in the 100 cycles between the end of block I and the beginning of block J. During this otherwise idle time for the PE 180, the LBIST manager 142 and LBIST circuitry 140 may run logic tests on the PE without interrupting execution of the machine learning network. For example, the LBIST manager 142 may communicate with the instruction manager 394 so that the LBIST manager 142 knows when the instruction fetch occurs. It then sets the LBIST enable during the instruction fetch for block J.

LBIST may also be enabled at other times. For example, it may be enabled between program start and when the first block of instructions is sent to PEs. This takes advantage of the memory latency to perform the LBIST. As another example, it may be enabled between program start and the start of instruction execution in PEs. This additionally uses the time needed to load all PEs with instructions since, for static scheduling, all PEs have instructions loaded before instruction execution with a PE can start.

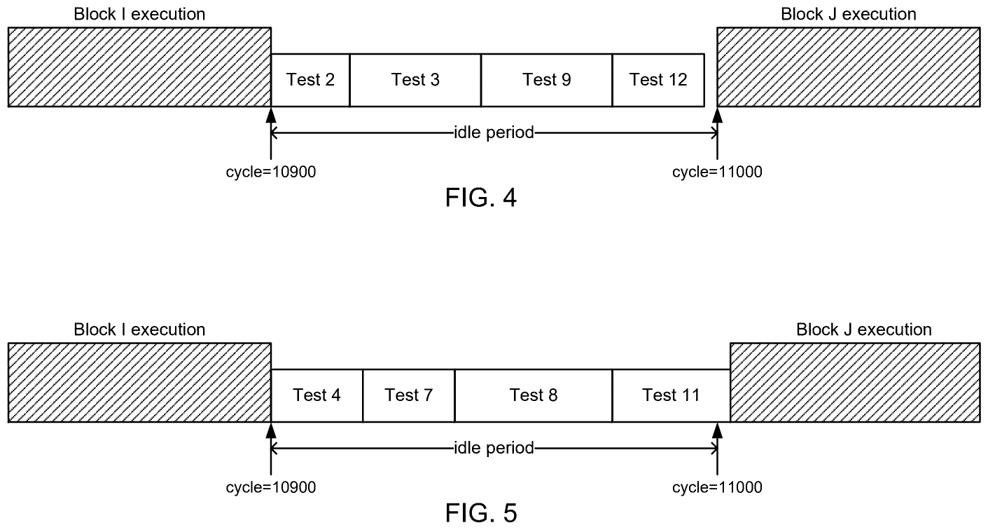

FIG. 4 is a timing diagram showing logic tests executed during idle time. Block I execution ends at cycle count=10900. Block J execution starts at cycle count=11000. Logic tests may be run in the idle period between these two cycle counts. In this example, there is a collection of logic tests that may be run. Tests which fit within the idle period are selected to be run. For example, tests 2, 3, 9, 12 have a total run-time of less than 100 cycles, so they may be run during the idle period. The test selection may be done by the LBIST manager 142 and/or by the LBIST circuitry 140 within the PE.

FIG. 5 is another timing diagram showing logic tests executed during idle time. In this example, the total run-time for the selected tests 4, 7, 8, 11 exceeds 100 cycles. The start time for block J is pushed back to provide enough time for the logic tests. In one approach, the cycle counter may continue to run and block J is adjusted to start at a cycle count later than 11000. In another approach, the cycle counter is suspended temporarily to allow the logic tests to complete. The suspension provides enough additional time buffer that block J can still start at cycle count=11000, but that cycle count is delayed in real time.

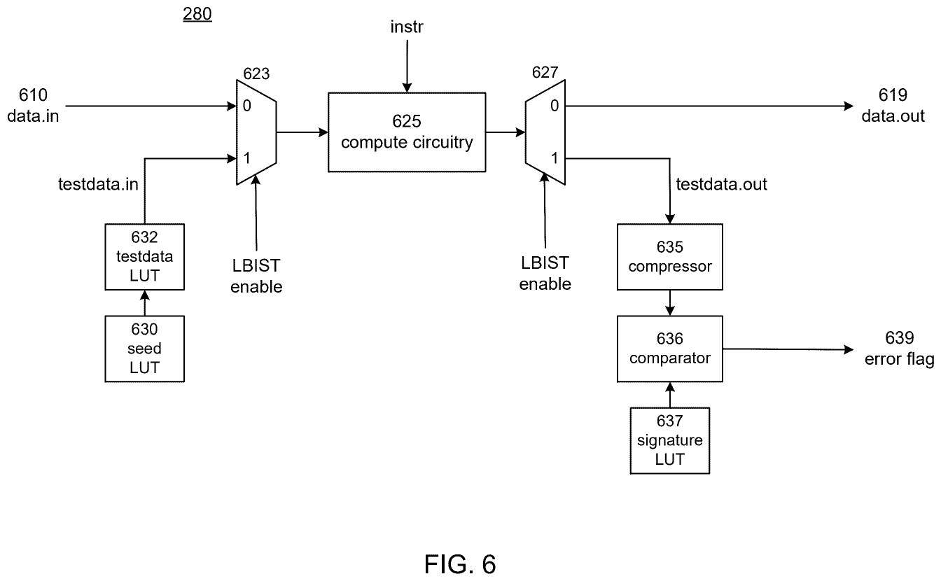

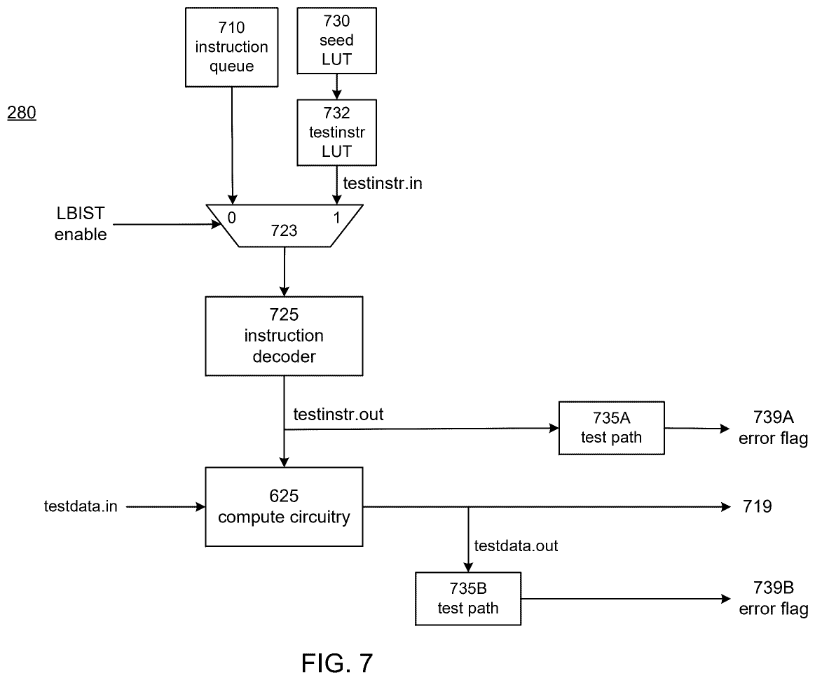

FIGS. 6 and 7 are specific examples of a processing element with LBIST. FIG. 6 is a block diagram of testing compute circuitry in a PE 680. The compute circuitry 625 executes certain functions according to the instructions that it receives. Examples of functions that might be tested include arithmetic operators (add/subtract, multiply, divide), cast between integer and floating point and vice-versa, logical operators (AND, OR, XOR etc.), logical and arithmetic shift operations, multiply-accumulate (MAC), state machines for various operations like matrix multiplication, convolution, pooling, upscale, reduce, scaling, etc., look-up tables, data transfer instructions within PEs. In FIG. 6, there is an operational data path 610-619 that performs calculations to implement the machine learning network, and there is a test path 630-639 that is used for LBIST. The multiplexer 623 and demultiplexer 627 determine which path is active, as controlled by the LBIST enable signal. Other arrangements may be used. For example, the output of the compute circuitry 625 may simply branch into the data output and test output paths, rather than using a demultiplexer 627. When LBIST is not enabled (LBIST enable=0), the data path 610-619 is active. The compute circuitry 625 receives data.in from 610, performs the calculation according to the received instruction, and outputs data.out at 619.

When LBIST is enabled (LBIST enable=1), the test path 630-639 is active. The input side of the test path generates the test input testdata.in. In this example, a seed lookup table (LUT) 630 provides a seed to LUT 632. In this example, the LUT 632 includes a random number generator whose output sequence is dependent on an initial seed value and LUT 630 contains a list of seed values. The LUT 632 then generates the test input based on the seed from LUT 630. This way, the same set of tests can be run with different testdata.in in order to get more test coverage.

If the compute circuitry 625 implements a single function, then no control is needed to select which function to test. If it is configurable to implement multiple functions, then the LBIST circuit will also generate test instructions to correctly configure the compute circuitry. The compute circuitry 625 produces the output testdata.out corresponding to input testdata.in. In FIG. 6, a compressor 635 compresses this output to produce a signature. A comparator 636 compares this signature to the signature of the expected output, as retrieved from LUT 637. For each seed in the seed LUT 630, a corresponding compressed signature is stored in signature LUT 637. The index used to select the seed from LUT 630 is also used to select the corresponding signature from LUT 637 for comparison. LUT 637 may have multiple tables depending on the instruction being tested in the compute circuitry 625. If the actual output and expected output do not match, an error flag 639 is set. In this example, the test path 630-639 is self sufficient. The LUTs 632, 637 provide the input data and expected output data used in the logic tests.

FIG. 6 shows circuitry for a single compute circuit, which may be referred to as a module under test in this context. The components in the test path 630-639 may or may not be shared between different modules under test. For example, if there are multiple modules under test that perform the same function, the same seed may be used for all modules. This effectively runs the same test for all modules. As a result, the same output analysis can also be performed for all modules. Components 630, 632, 635, 636, 637 may be shared, but producing different error flags for each module.

FIG. 7 is a block diagram of testing an instruction decoder in a processing element. The approach is similar to the testing of compute circuitry 625 in FIG. 6, except that the instruction decoder 725 is the module under test. multiplexer 723 selects between a control path 710-719 and a test path 730-739, based on the LBIST enable signal. When computing the machine learning network (LBIST not enabled), the control path 710-719 is active. Instructions from an instruction queue 710 are decoded by the instruction decoder 725 and used to control the compute circuitry 625.

When LBIST is enabled, the test path 730-739 is active. FIG. 7 shows two test paths to 739A/B, respectively. The input side of the test path generates the test instruction testinstr.in. In this example, a seed lookup table 730 provides a seed to instruction LUT 732, which then generates the test instruction testinstr.in. The instruction decoder 725 produces the corresponding instruction testinstr.out.

This may be evaluated for correctness in different ways. One approach is to directly evaluate testinstr.out. FIG. 7 shows a possible test path 735A branching from the output of the instruction decoder 725. The instruction testinstr.out is compared to the expected output of the decoder. An error flag 739A is set if the two do not match.

Another approach is to evaluate the correctness of the output of the compute circuitry 625. Errors in the instruction decoder 725 would be manifested as errors in the output of compute circuitry 625. FIG. 7 shows another possible test path 735B branching from the output of the compute circuitry 625. The testdata.out is compared to the expected output. If testinstr.out is not correct, testdata.out will also be incorrect. The test path 735B then generates an error flag 739B.

The instruction decoder 725 (or other control circuitry) and compute circuitry 625 (or other functional circuitry) may also be tested concurrently, combining FIGS. 6 and 7 for example.

The various LBIST components in FIG. 7 may also be shared between different modules under test and/or PEs, as described previously for FIG. 6. In addition, the outputs of the LBIST circuits for different PEs, for both FIGS. 6 and 7, may be connected into a chain for scan out of the error data or other test results from the different PEs. The scan chains may also be used to load test data or test instructions into the LUTs.

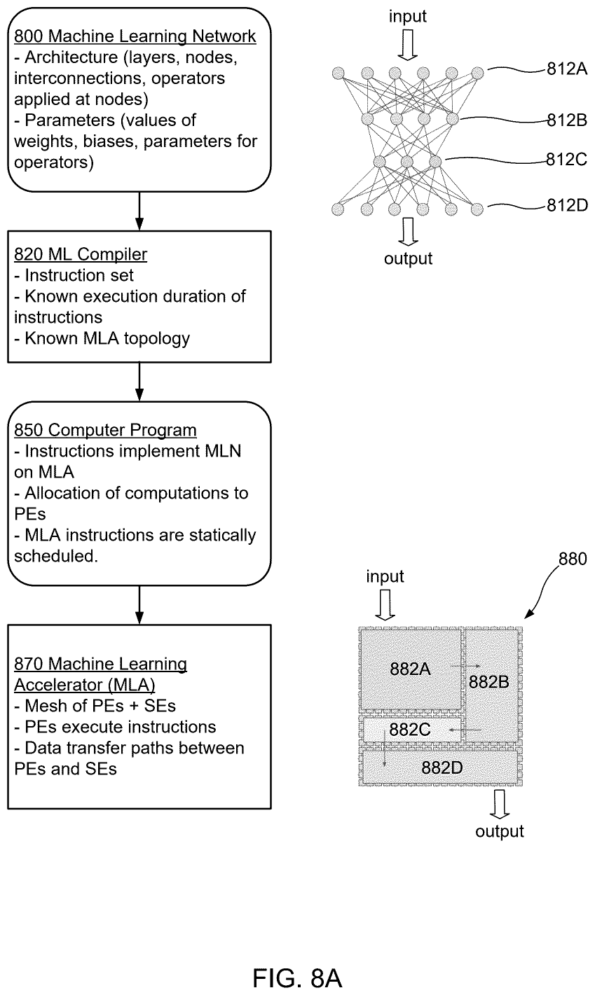

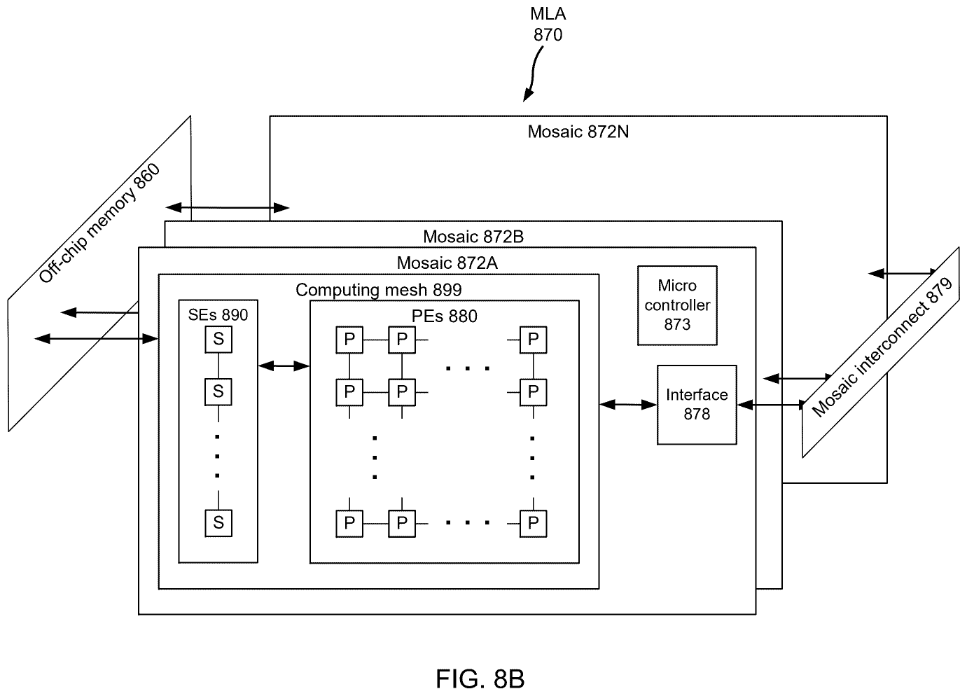

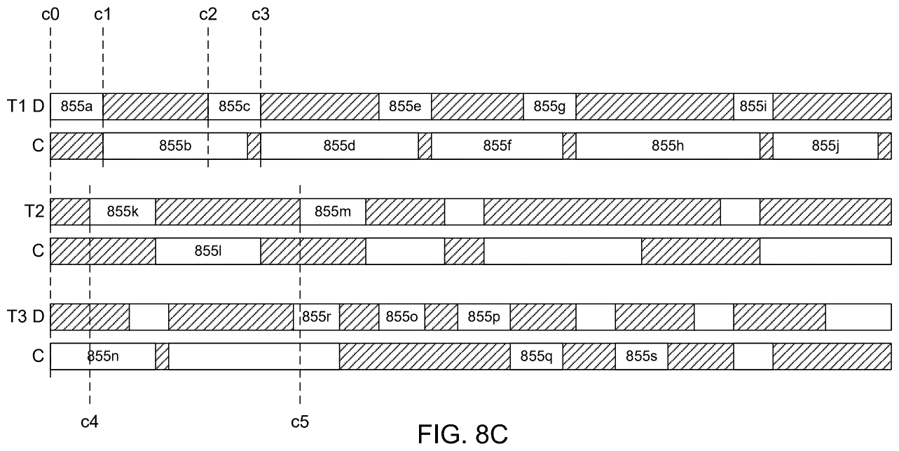

FIGS. 8A-8C are more detailed descriptions of an example system that executes a statically scheduled program, as may be used with the techniques described above. FIG. 8A is a block diagram of a system with a MLA and corresponding compiler. The MLA may be part of an edge device. The compiler 820 receives a description of a machine learning network 800 and generates a computer program 850 that implements the machine learning network using MLA 870. The computer program 850 includes instructions that are executed by processing elements (Tiles) and/or storage elements (on-chip memory) in the MLA according to a schedule determined by the compiler. Certain instructions may be statically scheduled with respect to each other, because the compiler can determine which instructions are executed by which compute elements at what times. For statically scheduled instructions, there are no conditions, branching or data dependencies that can be resolved only at run-time, and which would affect the timing and order of the execution of the instructions.

Note that the static schedule determined by the compiler may or may not be included as part of the instructions and computer program. In some embodiments, the computer program may expressly include the schedule, specifying that instruction A is executed at cycle X, instruction B is executed at cycle X+4, instruction C is executed at cycle X+12, etc. In alternate embodiments, the computer program may specify only that instruction A is executed, followed by instruction B, and then instruction C, but without any scheduling information. Even though the static schedule is not expressly specified, these instructions will still execute according to the static schedule determined by the compiler because the compiler knows how long it takes to execute each instruction. As a result of the static scheduling, the MLA and instruction set for the MLA may be simplified, with the complexity offloaded to the compiler. A simpler MLA can result in lower cost, lower power consumption and higher performance, all of which are desirable for implementation in edge devices.

In more detail, the MLN 800 may be described by an architecture and parameters. A depiction of an MLN is shown to the right of box 800 in FIG. 8A. Most MLNs include multiple layers 812, each with one or more nodes which are represented by circles in FIG. 8A. The lines between nodes in FIG. 8A represent interconnections between the nodes and layers. Each node calculates a weighted sum of the values received from its connected nodes, possibly also applying a bias. Examples are matrix multiplication and convolution. Each node may also apply certain functionality or operators, such as nonlinear functions (e.g., tanh function), softmax operator, etc. A typical node may compute an output:

y=F(Σwᵢxᵢ+b) (1)

where xᵢ are the inputs received from other nodes i, wᵢ are weights, b is a bias and F( ) is a nonlinear operator. The MLN architecture includes the number of nodes and layers and their interconnectivity, and the operators applied at nodes. The operators may be described in a parameterized form. The MLN parameters include the weights, biases, and parameters for the operators.

MLNs may vary in size, depending on the desired task. Small MLNs may have 8-10 or fewer layers, medium size MLNs may have 30-50 layers, and large MLNs may have 200 or more layers. Examples of inputs include text, images and video. Some of the layers may be fully interconnected where every node in one layer provides input to every node in the next layer. Others may be more locally interconnected, for example to implement convolutions. Each weighted interconnect represents a scalar multiplication. The total number of scalar multiplications required to implement an MLN may be on the order of millions, billions, tens of billions or even more. These may be carried out by matrix multiplications.

The MLA 870 includes many Tiles and an on-chip memory system with storage elements (not shown in FIG. 8A) implemented on a semiconductor die. The Tiles are organized into one or more meshes of interconnected Tiles. A depiction of a Tile mesh is shown to the right of box 870 in FIG. 8A. In this example, the Tiles 880 are organized in a regular pattern and the interconnections within each mesh provide data transfer paths between Tiles in the mesh. The Tiles execute computations according to instructions received by the Tiles and using data stored in the on-chip memory system. These instructions may be for computations and/or for data transfer. Computations include multiply (including matrix multiply), add, and operators (e.g., nonlinear functions, lookup table, min/max, pooling). These are computations that implement the MLN. In the example of FIG. 8A, the computations performed by layers 812A-D are allocated to groups 882A-D of Tiles as indicated. The allocation is not required to be 1:1. For example, multiple layers could be allocated to a single Tile or vice versa. Not every computation required to implement an MLN need be executed by a Tile; some computation may be executed outside the MLA (e.g., floating point operations, if the Tiles only do integer arithmetic). Tiles typically will at least perform matrix multiplication.

The compiler 820 receives a description of the MLN 800 and generates a computer program 850 that implements the MLN using the MLA 870. The computer program 850 receives an input sample for the MLN and executes the operations of the MLN to produce the output for the MLN. The computer program 850 includes instructions to be executed by the Tiles for implementing computations in the MLN and may also include instructions to be executed by other elements, such as the storage elements of the on-chip memory or a controller outside the Tiles.

The program of statically scheduled instructions may include a series of computations required to implement a portion of the MLN, where the time required for each computation and associated data transfers is known. As a result, the compiler may statically schedule these instructions. The resulting computer program produced by the compiler then implements an allocation of compute instructions to Tiles and a schedule for executing the instructions as determined by the compiler, although these may not be expressly contained with the computer program.

Non-deterministic instructions (i.e., instructions that are not statically scheduled) may also be used. For example, non-deterministic instructions may include data fetch and instruction fetch from off-chip memory where the time required to execute the operation varies too much to allow reliable synchronization with other operations. Other examples include computations that occur off-chip, and conditions, branching and other programmatic constructs that depend on values not known until run-time.

FIG. 8B is a block diagram of a hardware system including an MLA 870. The MLA 870 includes all the components shown in FIG. 8B, except the off-chip memory 860. The MLA components are implemented on a single die as part of a single chip. The MLA 870 includes one or more mosaics 872A-N. In this example, all of the mosaics are the same. Each mosaic 872 includes a computing mesh 899 that includes processing elements (PEs or Tiles) 880 and storage elements (SEs) 890. Each mosaic 872 also includes a controller 873. In FIG. 8A, the overall memory system is a multi-level memory system, which includes a level 1 (L1) memory distributed within the Tiles, a level 2 (L2) memory of SEs 890 which is shared by the Tiles, and the off-chip memory 860. If there are multiple mosaics 872, the MLA 870 may include a dedicated interconnect 879 for connecting the different mosaics. Each mosaic also includes an interface 878 to the interconnect 879. In FIG. 8B, The SEs 890 handle data transfer to and from the off-chip memory 860. The PEs 880 receive instructions from the off-chip memory 860. For convenience, the interface to off-chip memory 860 is not shown in FIG. 8B.

FIG. 8C illustrates execution of a statically scheduled program produced by a compiler. This example shows only instructions executed by PEs (Tiles) but the statically scheduled program typically also includes instructions executed by SEs. Execution of the static schedule begins at some time when all of the Tiles are synchronized, which for convenience is marked as cycle c0 in FIG. 8C. An external controller may synchronize the Tiles and start execution of the statically scheduled program when all Tiles are ready.

The example instructions shown in FIG. 8C are executed by three Tiles, as denoted by T1, T2 and T3. Each Tile has two pipelines: a “D” pipeline for executing data transfer instructions and a “C” pipeline for executing compute instructions. The row labeled T1 D shows instructions executed by the Tile 1 D (data transfer) pipeline, and the row labeled T1 C shows instructions executed by the Tile 1 C (compute) pipeline. For this example, assume that all the data transfer instructions are instructions that load new data into that Tile for consumption by the compute pipeline. The white regions of each row denote the execution of instructions and the hashed regions indicate that the pipeline is idling or executing a NO-OP (no operation).

For Tile 1, instruction 855a transfers data into Tile 1 from either another Tile or from ones of the SEs, and instruction 855b then performs a computation that consumes that data. Instruction 855b is dependent on instruction 855a. Here, the T1 C pipeline is not required to continuously poll the T1 D pipeline at run-time for when the data is available, and run-time message passing between the pipelines is not required to indicate that the data is available. Rather, because the duration (i.e., time required to execute) of instruction 855a is known, the compiler knows when the data will be available (for convenience, marked as cycle c1 in the figure) and can construct a static schedule in which instruction 855b starts execution then. The duration of instruction 855b is also known, so the compiler knows that compute instruction 855d may start after instruction 855b. In this case, the compiler determines a static schedule in which instruction 855d starts at cycle c3. Compute instruction 855d depends on data brought into the Tile by instruction 855c. The duration of instruction 855c is known, so the compiler knows that in the static schedule, instruction 855c must start at cycle c2 or earlier. This pattern is repeated for pairs of data transfer instructions and compute instructions 855e-f, 855g-h, 855i-j.

For Tile 2, compute instruction 855l depends on data from data transfer instruction 855k. However, instruction 855k does not start immediately at cycle c0. Rather, it has a delayed start at cycle c4. This may be because the data transfer path required by instruction 855k is occupied by some other data transfer instruction and is not available until cycle c4. The start time of instruction 855k in the static schedule is not determined by run-time arbitration or contention mechanisms for the shared data transfer path. Rather, the compiler knows that the data transfer path is occupied since the compiler knows the start times and durations of all the data transfer instructions, so the compiler simply creates a static schedule in which instruction 855k does not start until cycle c4 when the compiler knows the data transfer path will be available. Similarly, data transfer instruction 855m has a delayed start time. Perhaps the T2 D pipeline is being used to transfer out the results of computation 855l and does not become available until cycle c5.

For Tile 3, computation 855n starts immediately at cycle c0. Perhaps the required data was loaded into Tile 3 during some prior phase. Data transfer instructions 8550 and 855p load data for compute instruction 855q. They are separated in time, perhaps because different pieces of data were not available or the data transfer paths were not available until those times. As a final example, data transfer instruction 855r loads data for compute instruction 855s. In the static schedule, the compiler places instruction 855r well in advance of when the data is required, but this may be because that is when the data transfer path is available or perhaps the data was transferred out of the sourcing Tile in order to make room in that Tile.

Execution of the instructions according to the static schedule at run-time may be implemented in different ways. In one approach, the computer program includes an express schedule for the execution of the instructions. Continuing the example of FIG. 8C, the computer program may specify that instruction 855a executes at cycle c0, instruction 855b at cycle c1, instruction 855c at cycle c2, etc. Alternatively, the compiler may fill each instruction stream with NO-OPs to achieve the correct timing. A NO-OP (no operation) is an instruction that occupies a certain number of cycles without other activity. For example, the compiler knows that instruction 855a will end at cycle c1 and instruction 855b is supposed to begin at cycle c1. It may fill the space between cycles c0 and c1 with NO-OPs for the T1 C pipeline. The T1 C pipeline then just continuously executes instructions from its queue, and the NO-OPs ensure that instruction 855b is executed according to the compiler's static schedule. In yet another approach, the static schedule may be implemented by hardware. The T1 C pipeline may just stall on the execution of instruction 855b until the data from instruction 855a is ready. The compiler knows that data will be ready at cycle c1 and, therefore, instruction 855b will execute starting at cycle c1 even though the Tiles are unaware of the static schedule. Regardless of the implementation, for convenience, all of these situations will be described using the phrase “static schedule.” Thus, a statement that the compiler statically schedules the instructions is intended to include all of the above implementations and is not meant to imply that the computer program expressly includes a scheduled time for each instruction.

In order to statically schedule the instructions, the compiler typically will know the duration of each instruction (i.e., how long each instruction takes to execute), the capabilities of each Tile (which Tiles can execute which instructions), the topology of data transfer paths to and from Tiles (including between Tiles, and between Tiles and on-chip memory), and the computations required and their dependencies (i.e., the MLN description). With this information, the compiler can schedule unconditional start times for the Tile instructions. Here, unconditional refers to run-time conditions. The execution order of statically scheduled instructions will not change as a result of run-time conditions, branching or dependence on input values. As a result, compute instructions may be scheduled for start times when all of the required data for the computation is known to be available and the compute pipeline is also known to be available. The need for run-time determination of whether data has arrived and whether the compute pipeline is available may be avoided. Analogously, data transfer instructions may be scheduled for start times when the data transfer path is known to be available. The need for circuitry to handle arbitrations, or to check for or resolve contentions and collisions on shared data transfer paths at run-time may be avoided. The need for routing tables and other circuitry to determine routing at run-time may also be avoided.

The static schedule of FIG. 8C occurs within the computing mesh 899. The compiler assumes that instructions executed according to the static schedule have been fetched from the off-chip memory 860 in time for their execution, for example, that compute instruction 855b has been fetched from off-chip memory by cycle c1, and compute instruction 855d has been fetched by cycle c3. Similarly, the compiler also assumes that data used by instructions of the static schedule have also been retrieved from the off-chip memory 860 in time for their consumption. For example, if the data for data transfer instruction 855a is coming from off-chip memory, then it has been transferred to the relevant SE or PE by cycle c0, so it can then be transferred by instruction 855a to Tile 1. Similarly, the data for data transfer instruction 855c has been transferred to the relevant SE or PE by cycle c2.

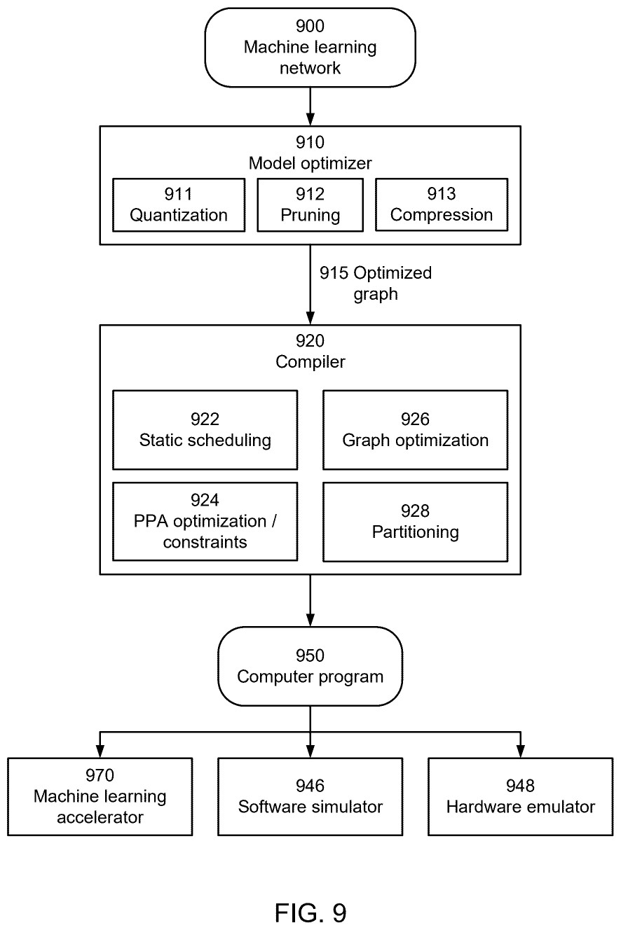

FIG. 9 is a block diagram of a software development environment including a machine learning (ML) compiler 920. In this example, the software development environment also includes a model optimizer 910. The model optimizer 910 receives a description of the MLN 900 and produces an optimized graph 915 of the MLN. It may apply optimizations such as quantization 911, pruning 912 and/or compression 913. Quantization 911 reduces the resolution of calculated values. For example, floating point values may be quantized to a certain number of bits and then integer math used instead of floating point math. This reduces the complexity and power consumed by the Tiles. Pruning 912 removes parts of the MLN that do not contribute significantly to the overall results. For example, if certain weights are zero or close to zero, those weighted interconnects may be pruned. Finally, because MLNs contain a large amount of data, compression may be used successfully to reduce data transfer bandwidths.

The resulting optimized description 915 of the MLN may be expressed as a graph, in which the nodes of the graph represent nodes in the MLN and the edges of the graph represent the weighted interconnects. The compiler 920 receives the optimized graph 915 and produces the resulting computer program 950. The compiler 920 may perform operations including static scheduling 922, PPA (power performance area) optimizations 924, graph optimizations 926 and/or partitioning 928.

In order to statically schedule 922 the deterministic instructions, the compiler typically will know the duration of each instruction (i.e., how long each instruction takes to execute), the capabilities of each element (which processing elements and storage elements can execute which instructions), the topology of data transfer paths to and from Tiles (including between Tiles, and between Tiles and on-chip memory), and the computations required and their dependencies (i.e., the MLN description). With this information, the compiler can schedule unconditional start times for the deterministic instructions. Here, unconditional refers to run-time conditions. The execution order of statically scheduled instructions will not change as a result of run-time conditions, branching or dependence on input values. As a result, compute instructions may be scheduled for start times when all of the required data for the computation is known to be available and the compute pipeline is also known to be available. The need for run-time determination of whether data has arrived and whether the compute pipeline is available may be avoided. Analogously, data transfer instructions may be scheduled for start times when the data transfer path is known to be available. The need for circuitry to handle arbitrations, or to check for or resolve contentions and collisions on shared data transfer paths at run-time may be avoided. The need for routing tables and other circuitry to determine routing at run-time may also be avoided.

PPA optimization 924 includes different optimizations of the computer program 950. For example, the allocation of MLN computations to Tiles may be optimized to reduce power consumption, to increase performance (such as reducing latency or increasing throughput) and/or to reduce area (e.g., number of Tiles used). The compiler 920 may also optimize 924 the computer program 950, subject to constraints on power, performance, area and/or any of the quantities described above. Graph optimization 926 includes analysis of the graph representing the MLN to prune, merge or quantize links, parameters, values, and layers to achieve better performance. Partitioning 928 concerns mapping the computations in the MLN to an implementation on the MLA. This includes determining which computations are allocated to which Tiles and how data flows through the mesh of Tiles during computation. If there are multiple mosaics, it also includes determining which computations are allocated to which mosaics.

The resulting computer program 950 may be loaded into memory for execution on a machine learning accelerator 970. For example, one possible application is object detection. In this case, the inputs are images captured by a video camera. The MLN 900 has been trained to identify certain objects in the video images. The computer program 950 implementing the MLN is loaded onto memory that is accessible by the MLA 970, which is implemented as a chip inside the camera. This way, images captured by the video camera may be immediately analyzed by the computer program 950 running on the MLA 970.

In addition to the MLA 970, the computer program 950 or parts of it may be run on a software simulator 946 and/or hardware emulator 948 (including FPGAs configured as MLAs). These may be used for product development, debugging and/or prototyping. For some purposes, a full simulation or emulation is not necessary. For example, to check that there are no collisions or conflicts between statically scheduled instructions, only the flow of data may be simulated or emulated. It is not necessary to compute actual values.

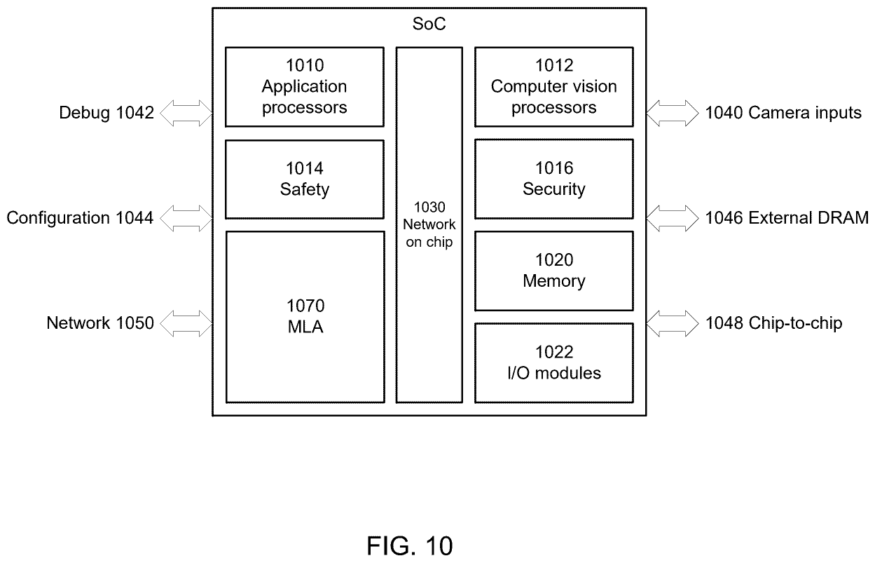

As discussed above, the MLA includes various components that are on the same die. The MLA may be integrated into a larger integrated circuit product (e.g., as part of an edge device). FIG. 10 is a block diagram of an integrated circuit that includes an MLA 1070. Other components may be included on the same die as the MLA. This example includes the following additional blocks: application processor 1010 (e.g., general purpose CPU running applications), computer vision processor 1012 (or other types of application-specific processors), safety 1014, security 1016, additional SRAM (memory) 1020 and input/output circuitry 1022. It also includes a network 1030 for communication between the different components. This type of semiconductor chip may be referred to as a system-on-chip (SoC).

The connections to the external world include camera inputs 1040 for the computer vision processors, ports for debug 1042 and configuration 1044, a connection 1046 to external memory (e.g., DRAM), chip-to-chip connections 1048, and network connections 1050 (e.g., Ethernet and PCIe).

The SoC of FIG. 10 may be combined with other components to perform various tasks in edge devices. Example applications for edge devices include automotive and other forms of transportation including autonomous transportation, agricultural, industrial, robotics, drones, surveillance and security, smart environments including smart cities, medical and personalized health. Example tasks include computer vision, image analysis, image understanding, speech recognition, audio analysis, audio understanding, natural language processing, classification and pattern recognition tasks. For edge devices, it may be desirable to perform certain tasks in real-time.

In addition to memory and other programmable processors, an edge device may also include sensors, such as cameras (both still image and video cameras), microphones, temperature sensors, pressure sensors and other types of sensors. The sensors may capture samples that are used as inputs to a computing pipeline within the edge device. For example, image samples may be input to the computer vision processors 1012, which perform initial operations such as edge detection and enhancement, contrast enhancement, motion detection, and optical flow. Raw and/or processed images may be then input to the MLA 1070 for analysis by the machine learning network. The MLA may also receive other inputs, such as metadata from other sources and data from other sensors. The application processors 1010 may also perform various functions in the overall pipeline and may also serve as a master controller that coordinates operation of the MLA and the other programmable processors in the pipeline.

Edge devices may be portable with less power available for computations compared to, for example, cloud-based server farms. It may also be desirable for the computing pipeline within the edge device to perform tasks without utilizing cloud-based or other remote compute resources. In some implementations, the MLA implements computations in the machine learning network at a speed of at least 50 TOPs (50 trillion operations per second) at a power consumption of not more than 5 watts. The speed may be increased by increasing the number of Tiles in the mesh or the number of Tile meshes on the die.

Although the detailed description contains many specifics, these should not be construed as limiting the scope of the invention but merely as illustrating different examples. It should be appreciated that the scope of the disclosure includes other embodiments not discussed in detail above. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

What is claimed is:

1. A machine learning accelerator (MLA) implemented on a semiconductor die, the MLA comprising:
a computing mesh of interconnected compute elements, the compute elements comprising:
functional circuitry that execute instructions;
control circuitry that control operation of the functional circuitry; and
Logic Built-In Self-Test (LBIST) circuitry configured to perform logic testing of the functional circuitry; and
an LBIST manager that enables the logic testing; wherein the compute elements execute a machine learning network comprising statically scheduled blocks of instructions, and the LBIST manager enables the logic testing during idle time of the functional circuitry between blocks.

2. The MLA of claim 1, wherein the LBIST manager enables the logic testing between an end time for execution of a previous block of instructions and a start time for execution of a next block of instructions.

3. The MLA of claim 1, wherein the LBIST manager enables the logic testing during instruction fetch for a next block of instructions.

4. The MLA of claim 1, wherein the logic tests to be performed are selected based on an estimated length of the idle time.

5. The MLA of claim 4, wherein an execution time of the selected logic tests fits within the estimated length of the idle time.

6. The MLA of claim 4, wherein an execution time of the selected logic tests does not fit within the estimated length of the idle time, and execution of the next block of instructions is delayed to accommodate execution of the selected logic tests.

7. The MLA of claim 1, wherein the LBIST circuitry is further configured to perform logic testing of the control circuitry.

8. The MLA of claim 7, wherein the LBIST manager enables concurrent logic testing of the functional circuitry and of the control circuitry.

9. The MLA of claim 7, wherein the functional circuitry includes adders and multipliers, and the control circuitry includes instruction decoders.

10. The MLA of claim 1, wherein the logic testing does not interrupt execution of the machine learning network.

11. The MLA of claim 1, wherein each compute element includes the LBIST circuitry that performs logic testing of the functional circuitry in that compute element.

12. The MLA of claim 11, wherein the LBIST manager comprises LBIST manager circuitry in each of the compute elements that enables the logic testing for that compute element.

13. The MLA of claim 11, wherein the LBIST circuitry in each compute element provides all input data used by the logic testing of that compute element.

14. The MLA of claim 13, wherein the LBIST circuitry in each compute element also provides all output data used to compare against outputs produced by the logic testing of that compute element.

15. The MLA of claim 11, wherein the LBIST manager comprises circuitry outside of the compute elements.

16. The MLA of claim 1, wherein the LBIST circuitry is further configured to generate error data indicating errors detected by the logic testing.

17. The MLA of claim 16, wherein the LBIST circuitry for different compute elements is connectable into a chain for scan out of the error data from the different compute elements.

18. The MLA of claim 1, wherein the compute elements further comprise: multiplexers that switch between data paths and test paths as inputs to the functional circuitry, based on an LBIST enable signal provided by the LBIST manager.

19. The MLA of claim 1, wherein the compute elements further comprise: branching of outputs of the functional circuitry to data paths and test paths.
